(19) United States
(12) Patent Application Publication
(10) Pub. No.: US 2014/0006551 A1
(43) Pub. Date: Jan. 2, 2014

(54) SYSTEM AND METHOD FOR BACKING UP DATA

(71) Applicant: Yuhan David YAO, Irvine, CA (US)

(72) Inventor: Yuhan David YAO, Irvine, CA (US)

(73) Assignee: NTI CORPORATION, Irvine, CA (US)

(21) Appl. No.: 13/540,426

(22) Filed: Jul. 2, 2012

(51) Int. Cl. G06F 15/16

(52) U.S. Cl. 709/217

(57) ABSTRACT

A system and a method for backing up data are disclosed. The system includes a cloud storage, a mobile application installed in a mobile device, and a local storage. The mobile application is launched to constantly check if data is processed in the mobile device. If the data is checked, the mobile application uploads the data from the mobile device to the cloud storage. The data in the cloud storage is downloaded to the local storage. The data in the cloud storage is deleted, after the data has been downloaded from the cloud storage to the local storage.

### BACKGROUND OF THE INVENTION

1. Field of the Invention

The present invention generally relates to data backup, and more particularly to a system and a method using a mobile application for backing up data.

2. Description of Related Art

As mobile devices become more powerful and convenient, users begin to store more of their personal data on the mobile device. For instance, built-in cameras in mobile devices have made it easier for users to take the pictures whenever the moment strikes. But, the problem with the mobile devices is that they can be easily lost, or the data may be negligently deleted, and consequently data backup is much more important than ever.

Conventional ways of backing up the data include using memory cards or external hard disks , or saving the data via email. However, the disadvantages of conventional backup techniques are the lack of mobility and flexibility in use, and in addition data can not be backed up instantly.

For the above noted reasons, and others, a need has arisen to propose a novel backup scheme that provides a mobile, customized, flexible, and convenient solution to users.

### SUMMARY OF THE INVENTION

In view of the foregoing, it is an object of embodiments of the present invention to provide a system and a method for instantly backing up data.

According to one embodiment, a system includes a cloud storage, a mobile application installed in a mobile device and a local storage. The mobile application is launched to constantly check if data is processed in the mobile device. If the data is checked, the mobile application uploads the data from the mobile device to the cloud storage. The data in the cloud storage is downloaded to the local storage. The data in the cloud storage is deleted, after the data has been downloaded from the cloud storage to the local storage.

### BRIEF DESCRIPTION OF THE DRAWINGS

FIG. 1A shows a schematic block diagram illustrating a system according to one embodiment of the present invention;

FIG. 1B shows a schematic block diagram illustrating a system according to another embodiment of the present invention;

FIG. 1C shows a schematic block diagram illustrating a system according to another embodiment of the present invention;

FIG. 1D shows a schematic block diagram illustrating a system according to another embodiment of the present invention; and

FIG. 2 shows a flow diagram illustrative of a method of backing up data processed in the mobile device by the system in FIG. 1A, according to one embodiment of the present invention.

### DETAILED DESCRIPTION OF THE INVENTION

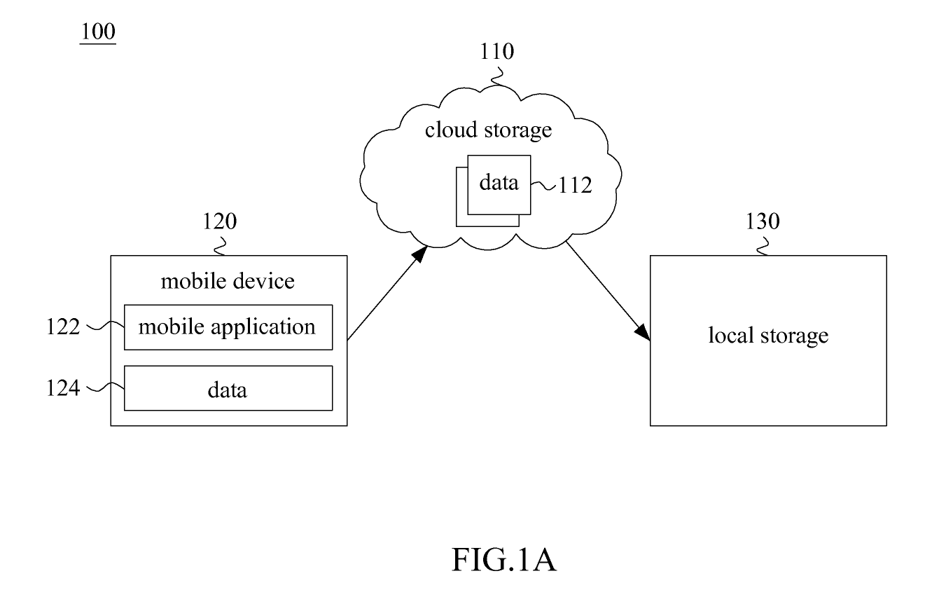

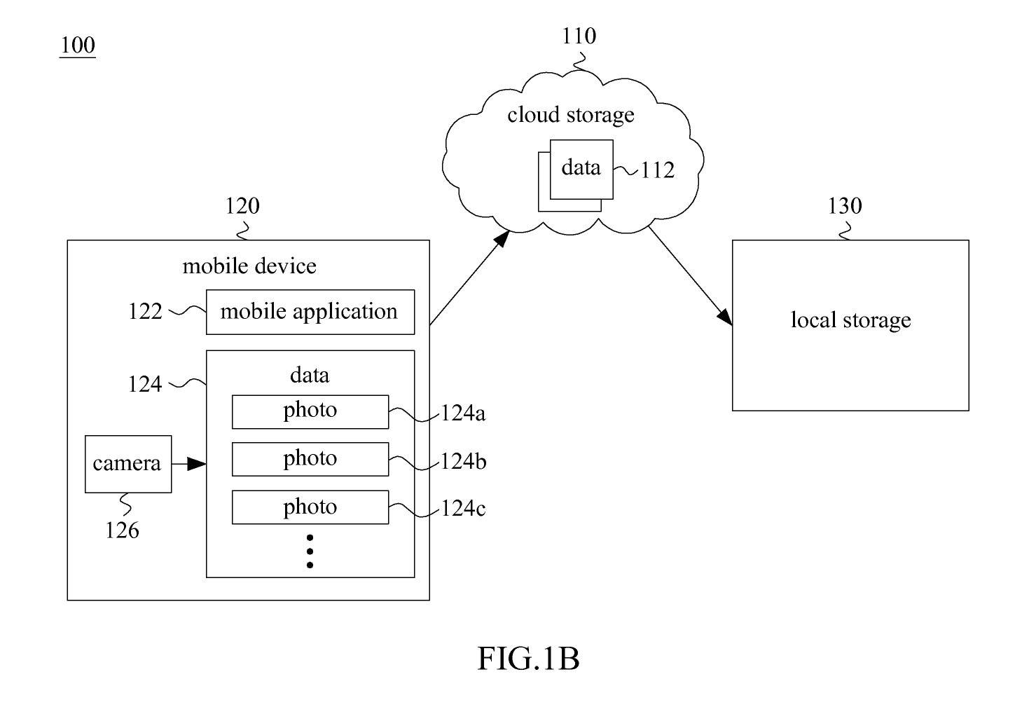

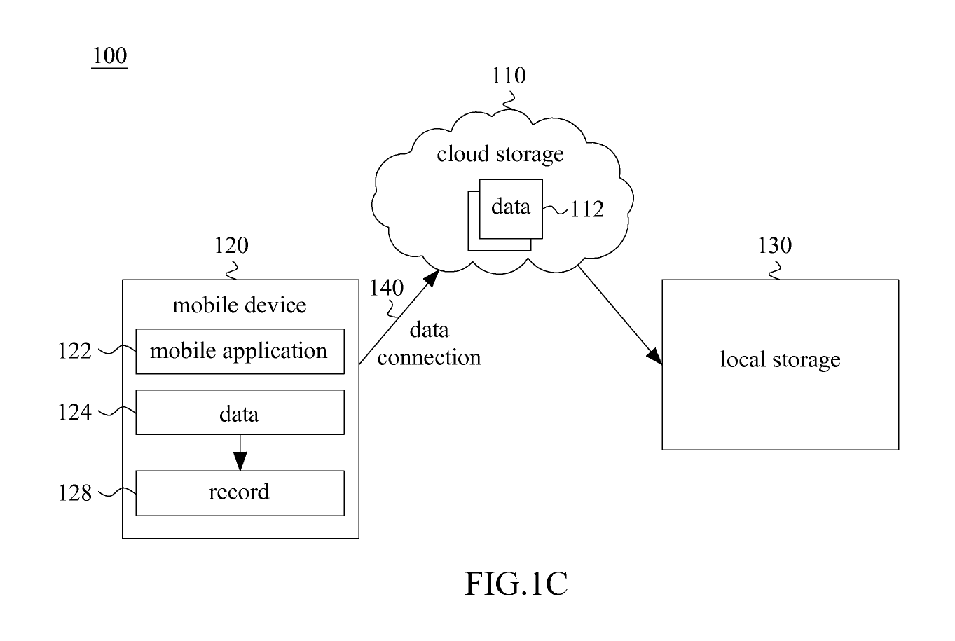

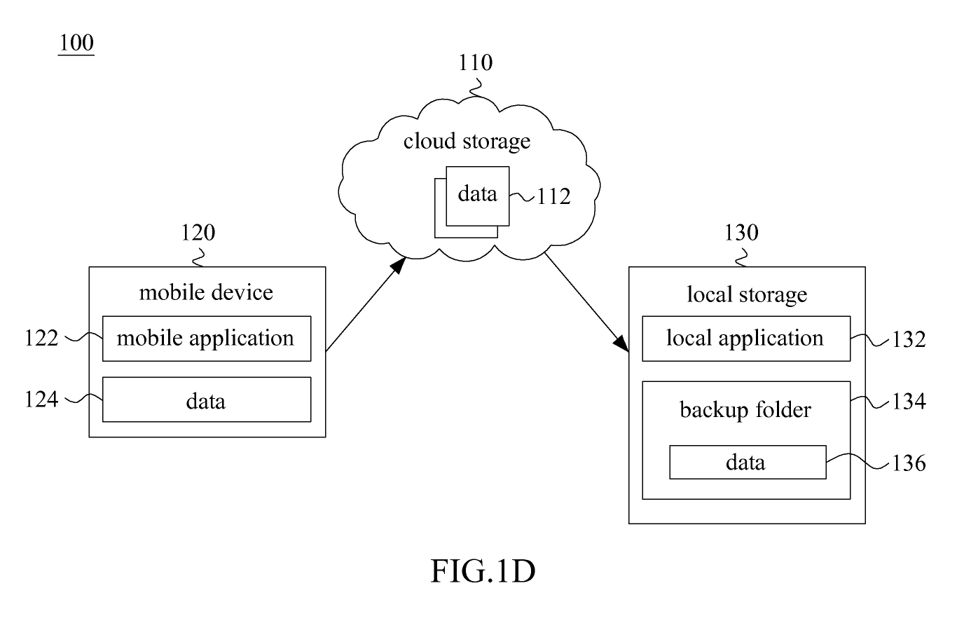

FIG. 1A shows a schematic block diagram illustrating a system 100 according to one embodiment of the present invention. The system 100 includes a cloud storage 110, a mobile application 122 installed in a mobile device 120 and a local storage 130. The mobile application 122 is launched to constantly check if data 124 is processed in the mobile device 120. If the data 124 is checked, the mobile application 122 uploads the data 124 from the mobile device 120 to the cloud storage 110. The data 112 in the cloud storage 110 is downloaded to the local storage 130. The data 112 in the cloud storage 110 is deleted, after the data 112 has been downloaded from the cloud storage 110 to the local storage 130.

In the embodiment, the mobile device 120 may preferably be such as, but not limited to, a mobile phone or a tablet. The local storage 130 may generally be a computer such as, but not limited to, a personal computer (PC), a notebook computer or a pocket PC.

FIG. 1B shows a schematic block diagram illustrating a system 100 according to another embodiment of the present invention. In the embodiment, the mobile device 120 includes a camera 126. The data 124 is a photo taken by the camera 126, such as photo 124a, photo 124b and photo 124c shown in the FIG. 1B.

FIG. 1C shows a schematic block diagram illustrating a system 100 according to another embodiment of the present invention. In the embodiment, before uploading the data 124 to the cloud storage 110, the mobile application 122 further determines whether a data connection 140 between the mobile device 120 and the cloud storage 110 is available. If it is determined that the data connection 140 is available, the mobile application 122 will instantly upload the data 124 to the cloud storage 110 through the data connection 140. On the other side, if it is determined that the data connection 140 is not available, the mobile application 122 will keep a record 128 of the data 124 which has been processed, but has not been uploaded to the cloud storage 110. Then, as soon as the data connection 140 becomes available, the mobile application 122 will immediately upload the data 124 in accordance with the record 128.

In the embodiment, the data connection 140 may preferably be such as, but not limited to, a WiFi connection (e.g., IEEE 802.11, IEEE 802.11b, etc.), a cellular data connection (e.g., CDMA2000, WCDMA, TD-SCDMA, WiMAX, LTE, etc), or a combination thereof. Moreover, in another embodiment of the present invention, if the mobile application 122 is launched for the first time, the mobile application 122 prompts a user to confirm whether to upload the data 124 to the cloud storage 110 automatically.

FIG. 1D shows a schematic block diagram illustrating a system 100 according to another embodiment of the present invention. In the embodiment, the local storage 130 further includes a local application 132. The local application 132 is launched to monitor if the data 112 has been downloaded from the cloud storage 110 to a backup folder 134 in the local storage 130. Furthermore, if the data 112 has been downloaded to the local storage 130, the local application 132 can display the data 136 in the backup folder 134.

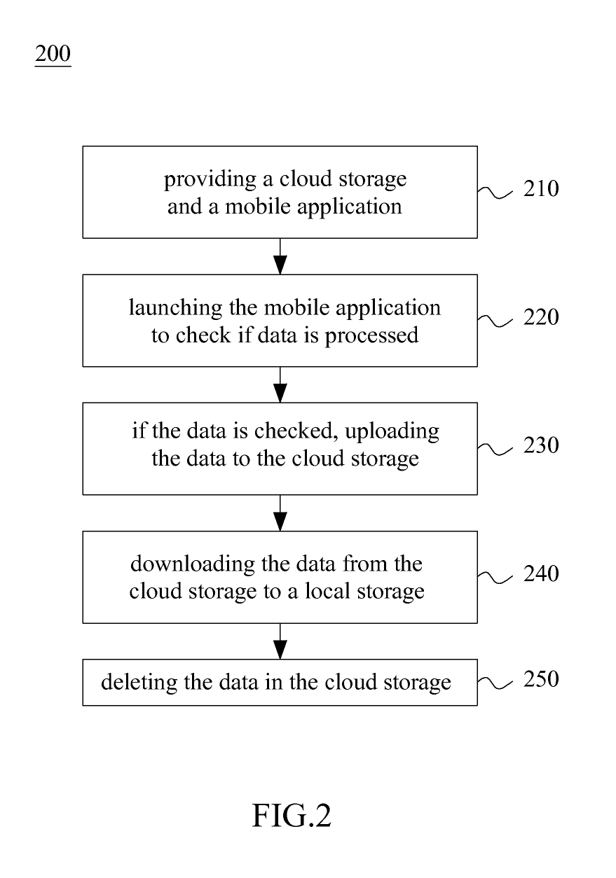

FIG. 2 shows a flow diagram illustrative of a method of backing up data 122 processed in the mobile device 120 by the system 100 mentioned above, according to one embodiment of the present invention. The method 200 includes providing a cloud storage 110 and a mobile application 122 installed in a mobile device 120 (step 210); then, launching the mobile application 122 to constantly check if data 124 is processed in the mobile device 120 (step 220); moreover, if the data 124 is checked, uploading the data 124 from the mobile device 120 to the cloud storage 110 (step 230); subsequently, downloading the data 112 from the cloud storage 112 to a local storage 130 (step 240); and deleting the data 112 in the cloud storage 110, after the data 112 has been downloaded from the cloud storage 110 to the local storage 130 (step 250).

In another embodiment, in step 220, if the mobile application 122 is launched for the first time, the user is further prompted to confirm whether to upload the data 124 to the cloud storage 110 automatically.

In a further embodiment of the present invention, before uploading the data 124 to the cloud storage 110 in step 230, the method 200 further includes determining whether a data connection 140 between the mobile device 120 and the cloud storage 110 is available. If it is determined that the data connection 140 is available, the data 124 will instantly be uploaded to the cloud storage 112. On the other hand, if it is determined that the data connection 140 is not available, the data, which has been processed but hasn't been uploaded, will be kept in a record 128 and then be uploaded to the cloud storage 110 in accordance with the record 128 as soon as the data connection 140 becomes available.

As for step 240, in one embodiment of the present invention, the method 200 further includes launching a local application 132 installed in the local storage 130 to monitor if the data 112 has been downloaded to a backup folder 134 in the local storage 130. Also, if the data 112 has been downloaded to the local storage 130, the user may click the local application 132 to display the data 136 in the backup folder 134.

According to the embodiment described above, the system and the method provided in the present invention are capable of using the mobile application to instantly perform the data backup through the cloud storage to the local storage, therefore substantially protecting the data on the mobile device and providing flexibility and convenience in use.

Although specific embodiments have been illustrated and described, it will be appreciated by those skilled in the art that various modifications may be made without departing from the scope of the present invention, which is intended to be limited solely by the appended claims.

What is claimed is:

1. A system of instantly backing up data, comprising:
a cloud storage; and
a mobile application installed in a mobile device, wherein the mobile application is launched to constantly check if data is processed in the mobile device; if the data is checked, uploading the data from the mobile device to the cloud storage; and
a local storage, wherein the data in the cloud storage is downloaded to the local storage;
wherein the data in the cloud storage is deleted, after the data has been downloaded from the cloud storage to the local storage.

2. The system of claim 1, wherein the mobile device is a mobile phone or a tablet.

3. The system of claim 1, wherein the local storage is a computer.

4. The system of claim 1, wherein the mobile device comprises a camera.

5. The system of claim 4, wherein the data is a photo taken by the camera.

6. The system of claim 1, wherein if the mobile application is launched for the first time, the mobile application prompts a user to confirm whether to upload the data to the cloud storage automatically.

7. The system of claim 1, wherein before uploading the data to the cloud storage, the mobile application further determines whether a data connection between the mobile device and the cloud storage is available; if it is determined that the data connection is available, instantly uploading the data to the cloud storage; and if it is determined that the data connection is not available, keeping a record of the data which has been processed and then uploading the data in accordance with the record when the data connection becomes available.

8. The system of claim 7, wherein the data connection is a WiFi connection, a cellular data connection or a combination thereof.

9. The system of claim 1, wherein the local storage further comprises a local application launched to monitor if the data has been downloaded to a backup folder in the local storage.

10. The system of claim 9, wherein if the data has been downloaded to the local storage, the local application displays the data in the backup folder.

11. A method of backing up data, comprising:
providing a cloud storage and a mobile application installed in a mobile device;
launching the mobile application to constantly check if data is processed in the mobile device;
if the data is checked, uploading the data from the mobile device to the cloud storage;
downloading the data from the cloud storage to a local storage; and
deleting the data in the cloud storage, after the data has been downloaded from the cloud storage to the local storage.

12. The method of claim 11, wherein the mobile device is a mobile phone or a tablet.

13. The method of claim 11, wherein the local storage is a computer.

14. The method of claim 11, wherein the mobile device comprises a camera.

15. The method of claim 14, wherein the data is a photo taken by the camera.

16. The method of claim 11, further comprising:
if the mobile application is launched for the first time, prompting a user to confirm whether to upload the data to the cloud storage automatically.

17. The method of claim 11, before uploading the data to the cloud storage, further comprising:
determining whether a data connection between the mobile device and the cloud storage is available;
if it is determined that the data connection is available, instantly uploading the data to the cloud storage; and
if it is determined that the data connection is not available, keeping a record of the data has been processed and then uploading the data in accordance with the record when the data connection becomes available.

18. The method of claim 17, wherein the data connection is a WiFi connection, a cellular data connection, or a combination thereof.

19. The method of claim 11, further comprising:
launching a local application installed in the local storage to monitor if the data has been downloaded to a backup folder in the local storage.

20. The method of claim 19, further comprising:
if the data has been downloaded to the local storage, displaying the data in the local storage.
